(19) United States
(12) Patent Application Publication
(10) Pub. No.: US 2005/0165733 A1
(43) Pub. Date: Jul. 28, 2005

(54) System and method for an in-memory roll up-on-the-fly OLAP engine with a relational backing store

(75) Inventor: Eric Strovink, Southborough, MA (US)

Correspondence Address: BOURQUE & ASSOCIATES, P.A., 835 HANOVER STREET, SUITE 303, MANCHESTER, NH, 03104, US

(73) Assignee: BIQ, LLC

(21) Appl. No.: 11/035,668

(22) Filed: Jan. 14, 2005

Related U.S. Application Data
(60) Provisional application No. 60/536,417, filed on Jan. 14, 2004.

(51) Int. Cl. G06F 7/00

(52) U.S. Cl. 707/2

(57) ABSTRACT

A system and method having an in-memory rollup-on-the-fly OLAP engine with a relational backing store. The system and method allow for modification to the structure of the in-memory rollup-on-the-fly OLAP engine in real time during operation. These modifications may be written to its backing store in real time and include changes both to Fact Values and to Dimensional Hierarchies.

### RELATED APPLICATION

This application is related to and claims priority from US provisional application 60,536,417 filed Jan. 14, 2004 and fully incorporated herein be reference.

### TECHNICAL FIELD OF THE INVENTION

The present invention relates to an on-line-analytical processing (OLAP) performed within computer systems as well as OLAP systems and more specifically, to an in-memory rollup-on-the-fly OLAP engine with a relational backing store.

### DESCRIPTION OF THE RELATED ART

Relational databases store information in index tables that are organized into rows and columns. A user retrieves information from the tables by entering a request that is converted to queries by a database application, which then submits the queries to a database server. In response to the queries, the database server accesses the tables specified by the queries to determine which information, if any, within the table satisfies the queries. The information that satisfies the queries is then retrieved by the database server and transmitted to the database application and ultimately to the user.

On-Line analytical processing (hereinafter “OLAP”) applications, also known as decision support processing applications, are applications that provide analysis of data stored in a database. Examples of analytic functions are those functions used in basic business intelligence calculations such as moving averages, rankings, and lead/lag comparisons of data. Analytic functions are broadly classified as window functions. Window functions are so named because they operate over a set of rows of data in the database tables. The set of rows upon which the window functions operate described by a window definition or window size. The window size describes which rows qualify for the window. The window has a starting row and an ending row. For example, a window defined for a moving average would have both the starting and ending points of the window slide so that the endpoints maintain a constant physical or logical range.

OLAP allows business users to dissect, or slice and dice data at will. Normally, data in an organization is distributed in multiple data sources and are incompatible with each other. For example, point-of-sales data and sales data made via call center or the Web are generally stored in different locations and formats.

Part of the OLAP implementation process involves extracting data from the various data repositories and making them compatible. Making data compatible involves insuring that the meaning of the data in one repository matches all other repositories. It is not always necessary to create a data warehouse for OLAP analysis. Data stored by operational systems, such as point-of-sales, are in types of databases called On-line Transaction Processing (hereinafter “OLTP”). OLTP databases are not different, from a structural perspective, from any other database. The main difference, and only difference, is the way in which data is stored.

The problem with existing OLAP applications is their inability to reconfigure themselves, while operating, to reflect desired changes in data organization or in data value as those changes are deemed to be necessary by a user. Instead, existing OLAP applications need to be taken offline, re-organized with offline procedures and tools, run through a re-calculation phase, and then brought back online, which is a tedious process that makes OLAP untenable for on-the-fly analysis. In other words, existing OLAP applications: 1) are unable to change transaction values in real time; 2) do not allow for changes to (and creation of) new hierarchy nodes (that represent groups of other nodes) in real time; and 3) cannot support any new analysis not inherent in their pre-defined structure.

### SUMMARY OF THE INVENTION

The present invention is a system and method having an in-memory rollup-on-the-fly OLAP engine with a relational backing store. The system and method allow for modification to the structure of the in-memory rollup-on-the-fly OLAP engine in real time during operation. These modifications may be written to its backing store in real time and include changes both through Fact Values and to Dimensional Hierarchies. Further, with slight delays, the modifications extend to creation of new Dimensions and deletion and cloning of existing Dimensions. The system and method provide a mutable OLAP engine ideally suited for a “what if analysis” and for supporting on-the-fly database enrichment and enhancement.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

### BRIEF DESCRIPTION OF THE DRAWINGS

These and other features and advantages of the present invention will be better understood by reading the following detailed description, taken together with the drawings wherein:

FIG. 1A illustrates Value Chains having unique dimensions and values, wherein the values are actual values and not NodeID's before transformation;

FIG. 1B illustrates a unified Value Chain Header indexed by NodeID and NodeID values, wherein the NodeID values are substituted into Fact, and the Result Array is indexed by NodeID according to the present invention;

FIG. 2 illustrates the Node structure according to the present invention;

FIG. 3 illustrates how the rollup occurs across Sibling Pointers, wherein the MaxLevel is first, and each level in turn adds its accumulation contribution to its Parent Node buckets according to the present invention; and

FIG. 4 illustrates all other Node creations according to the present invention.

### DETAILED DESCRIPTION OF THE PREFERRED EMBODIMENTS

XLAP is a system and method having an in-memory rollup-on-the-fly OLAP engine with a relational backing store. XLAP is an extended OLAP engine. XLAP differs from other OLAP engines in that its structure is modifiable in real time (i.e. while it is operating). These modifications are also written to its backing store in real time. Modifications include changes both to Fact Values and to Dimensional Hierarchies. With slightly longer delays, typically under 1 minute, the modifications extend to creation of entirely new Dimensions, and deletion and cloning of existing Dimensions. The result is a mutable OLAP engine, ideal for “what if” analysis, and supporting on-the-fly database enrichment and enhancement. This is in direct contrast to the normal OLAP database, which is typically a read-only entity, and, therefore, cannot support any new analysis not inherent in its pre-defined structure.

In addition, XLAP creates new rollup nodes on-the-fly, as needed, in support of its unique “All Others” feature. Roll up is the process of further aggregating the data, for example, aggregating certain items from the previously targeted data. An XLAP user can request that only the top N results be returned, and the rest collapsed into a single “All Others” result. This All Others result is a real result, remembered by the engine, and able to be referenced in all subsequent queries.

Despite its mutability, XLAP is a very high performance engine. It is structured so that it rolls up all dimensions all the time, as opposed to OLAP engines that only consider one dimension at a time. Thus, an XLAP data viewer is able to show the effect of any drill operation on all dimensions, without “pivoting” to those dimensions, since all dimensions are updated simultaneously. XLAP makes the OLAP “pivot” operation obsolete.

XLAP optimizes its internal structures to provide for minimal access time for its real-time rollup operations. It re-keys Fact Values, laying them out in a linear array that is accessed by modern processors without complex dereferencing, therefore maximizing memory bandwidth utilization. XLAP also optimizes its query paths, not only by ordering logical operations optimally, and choosing the shortest query execution path, but also by evaluating the impact of each query path on the actual comparison logic needed to address other clauses in the query. This key improvement means that XLAP can operate quickly on queries that would ordinarily swamp other engines - - - specifically, queries involving All Others nodes that contain hundreds of thousands of entries.

For example, All Others is useful to contain the “tail” of a distribution. Suppose that the dataset had a Customer dimension, and the user was interested in the top 50 customers. The remaining 2,000 customers would normally be excluded from analysis in a conventional OLAP system, which means that the totals from that analysis would not “tie out” to any other number, for example a result from a separate Accounting or Sales Tracking system. However, XLAP provides a method for these remaining 2,000 customers to be grouped together in a single All Others node, which means that the totals from the XLAP analysis continue to track the summary totals from other systems. XLAP's ability to optimize query paths when grouping large numbers of nodes together for All Others calculation is critical for high-speed operation.

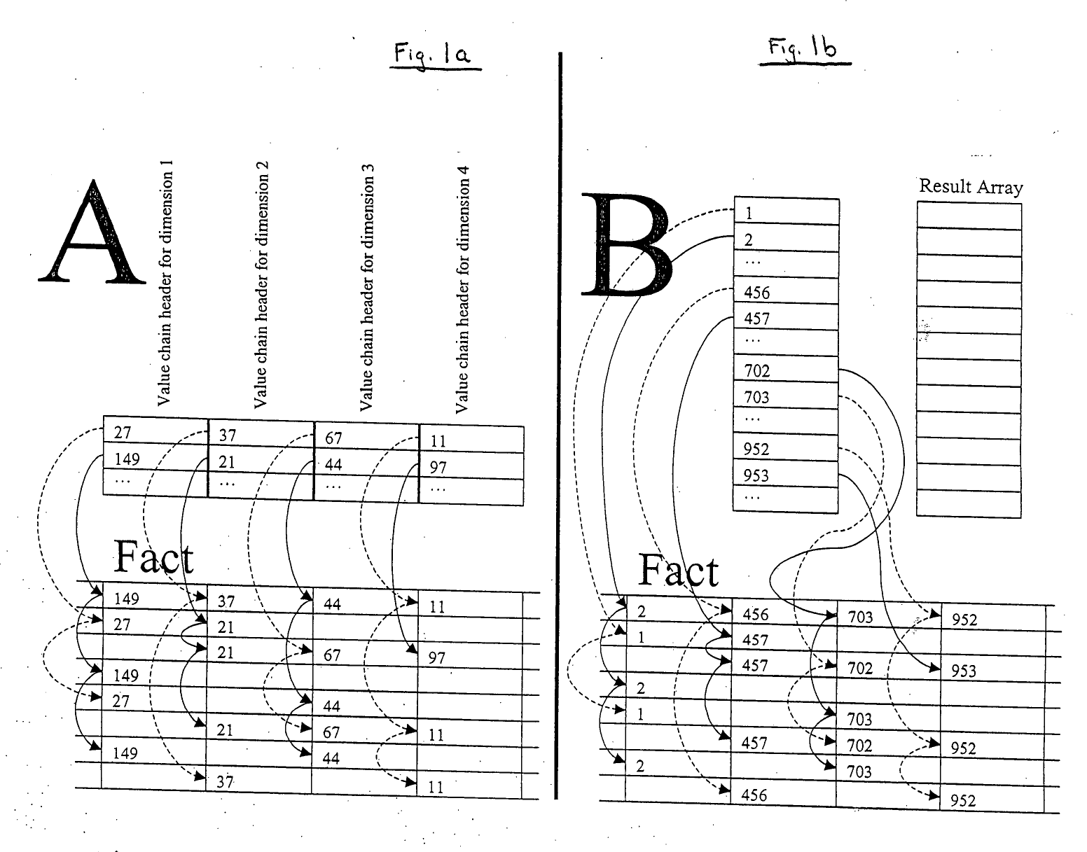

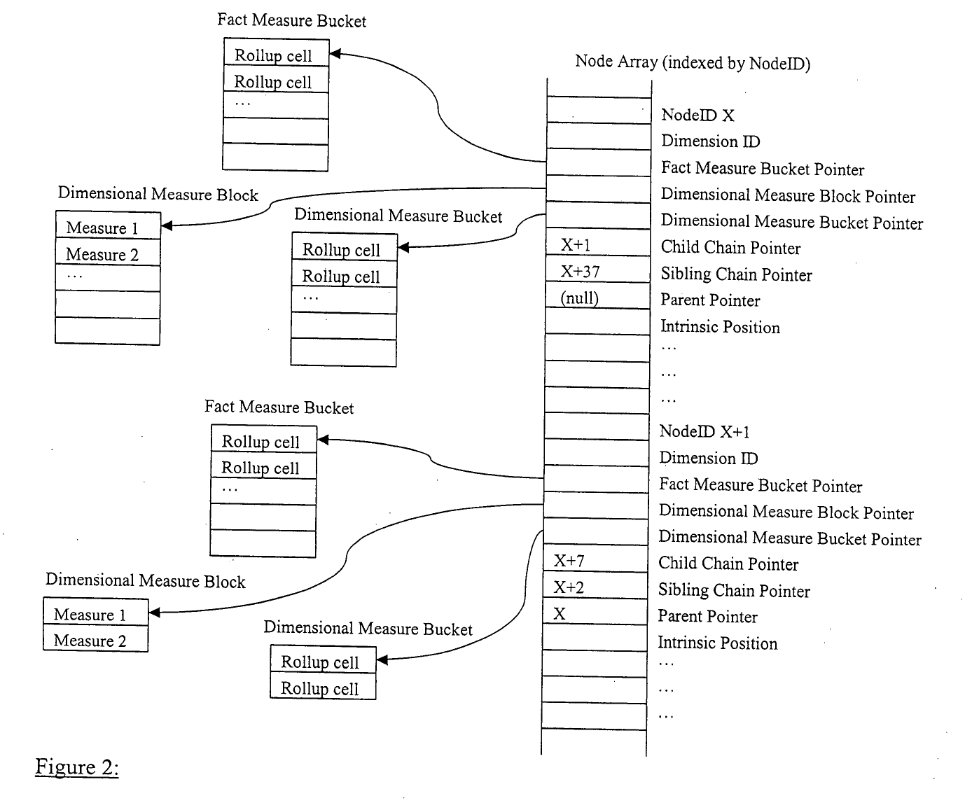

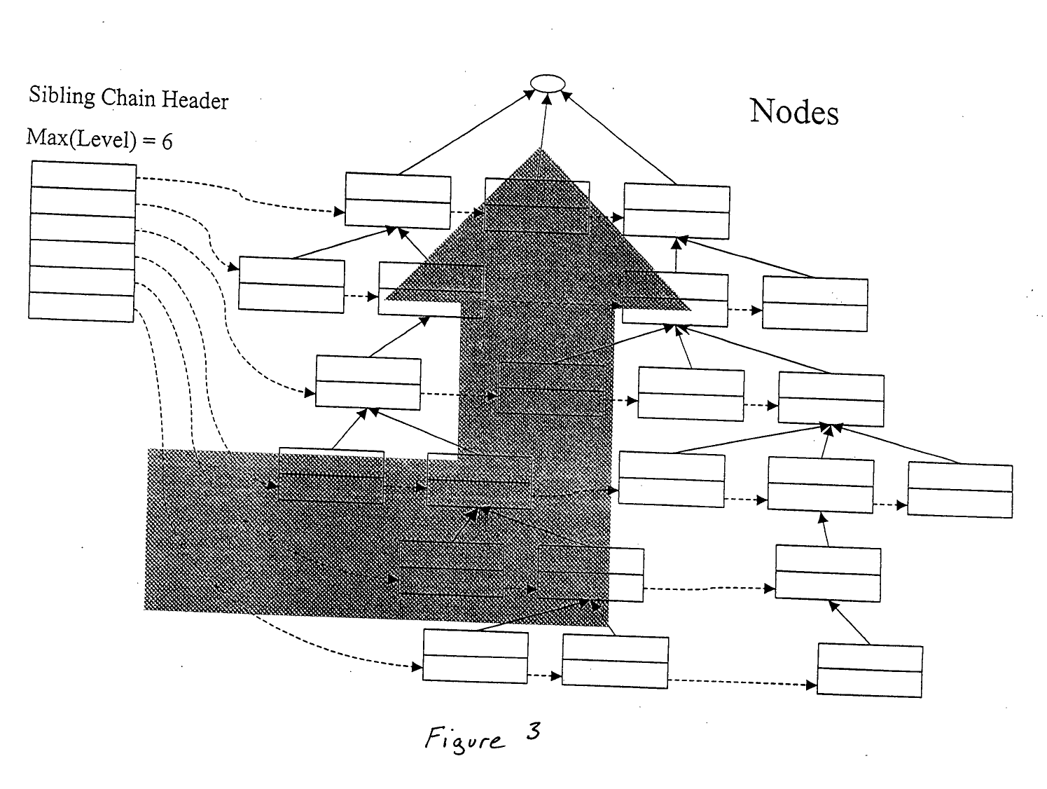

Further, the OLAP power of XLAP is used for two purposes not normally intrinsic to a database engine. First, XLAP queries can be issued as part of a Mapping request, such that all nodes visited by the query have their values adjusted. This means that the XLAP engine itself accomplishes data cleansing and mapping operations that normally require extensive outside support systems and programs much more quickly, and while the engine is running. Second, XLAP has built-in data export facilities that use OLAP queries to assist the relational engine in returning data to users. This export facility uses XLAP's OLAP power to perform the costly joins that would otherwise bog down a relational engine, creating a temporary index table that is then used by the relational engine to return its results at speed.

| “rolls up” | see Measure |
|---|---|
| All Others | a Node that is allocated in real time to maintain |
| Node | roll up quantities for a potentially large number |
| | of other Nodes. The purpose of the All Others |
| | node is to enable the XLAP user to create a |
| | holding place for the enumeration of other, less |
| | interesting, but potentially extremely numerous |
| | Nodes. |
| Child Chain | threads through the Child Chain Pointers of the |
| | child Nodes of a Parent Node. Anchored by the |
| | parent Node's Child Chain Pointer. See FIGS. |
| | 1, 3. |
| Comparison | the cost of comparing a NodeID within a |
| Cost | Transaction to a list of values |
| Database | a collection of tables that include a Fact table |
| | as well as various Dimension information tables |
| | and optional Dimension Index tables |
| Dimension | a set of Nodes organized (through their Parent |
| | and Child pointers) as a hierarchy tree |
| Dimension | a table that provides extra information about a |
| Index | Dimension, such as human-readable names for its |
| | Nodes |
| Dimensional | a Dimension field that logically rolls up along |
| Measure | just this one dimension. An example is “number |
| | of employees” on the Organization dimension. |
| Dimensional | an array of Dimensional Measure cells that hold |
| Measure Block | the Dimensional Measures for a particular Node. |
| | See FIG. 2. |
| Dimensional | an array of Rollup Cells corresponding to the |
| Measure | defined Dimensional Measures for a particular |
| Bucket | Dimension. There is one Dimensional Measure |
| | Bucket for each Node of a Dimension that has |
| | defined Dimensional Measures. See FIG. 2. |
| Fact | the collection of all Transaction records |
| Fact Measure | an array of Rollup Cells corresponding to the |
| Bucket | defined Measure fields within Fact. There is one |
| | Fact Measure Bucket per Node. See FIG. 2. |
| Hierarchy | same as Dimension |
| Intermediate | a node that is not at the deepest level of a |
| Node | hierarchy, i.e. it points to Child Nodes. |
| Leaf Node | a node at the deepest level of a hierarchy |
| Level | the position of a Node within a dimensional |
| | hierarchy. Level 1 nodes have no parent; Level 2 |
| | nodes have exactly one Level 1 parent; and so on. |
| | See FIG. 3. |
| Max (Level) | the deepest level of the deepest Hierarchy. See |
| | FIG. 3. |
| Measure | a Fact field that logically rolls up along all |
| | dimensions. For example, “revenue received” |
| | rolls up along the Time dimension such that |
| | Months are the total of Weeks, Quarters are the |
| | total of Months, Years are the total of Quarters, |
| | and so on. See FIG. 2. |
| Node | a position within a dimensional hierarchy. Each |
| Child Node | node contains a NodeID that is unique across all |
| Parent Node | nodes and all Dimensions, a name, a Sibling Chain |
| | Pointer, a Child Chain Pointer, a Fact Measure |
| | Bucket Pointer, a Dimensional Measure Bucket |
| | Pointer, and a Dimensional Measure Block pointer. |
| | The Node also contains a Parent pointer to its |
| | parent Node, a Child Pointer which anchors the |
| | Child Chain Pointers of its child Nodes, and an |
| | All Others parent, which is a temporary node |
| | created from time to time and described in the |
| | “All Others” section, below. Nodes at the top of |
| | the hierarchy have a NULL Parent pointer. Nodes |
| | at the bottom of the hierarchy, or Leaf Nodes, |
| | have a NULL Child Pointer. Some dimensions, like |
| | Time, have a notion of intrinsic ordering of |
| | Nodes. This intrinsic ordering is also stored |
| | with the Node. See FIG. 2. |
| Query | an OLAP query of the form <or clause> AND <or |
| | clause> AND . . . AND <or clause>. Each <or |
| | clause> is of the form Dx = Ky1 OR Dx = Ky2 OR . . . |
| | OR Dx = Kyn, where x is a dimension and yN is a |
| | NodeID of that dimension |
| Result Set | the set of transactions that are touched by a |
| | Query |
| Result Array | a contiguous block of memory indexed by NodeID, |
| | containing a truth value indicating whether the |
| | associated NodeID should be included in a Result |
| | Set. See FIG. 1. |
| Rollup Cell | a value cell containing rolled up quantities |
| | along a Dimension, as calculated by XLAP. See |
| | FIG. 2. |
| Sibling Chain | a singly-linked chain threading through all the |
| | Sibling Chain Pointers of Nodes at the same |
| | Level, across all Dimensions. See FIG 3. |
| Sibling Chain | an array of <root pointer to Sibling Chain>, of |
| Header | size Max (Level). See FIG. 3. |
| Transaction | a record within the Fact table, consisting of a |
| | unique transaction ID, one or more NodeID's, and |
| | one or more Measures. For each NodeID, there is |
| | also a Value Chain Pointer. |
| Value Chain | a singly-linked list threading through all the |
| | Value Chain Pointers of Transactions associated |
| | with a particular value of a Dimensional Key. |
| | See FIG. 1B. |
| Value Chain | an array of tuples of the form <count><root |
| Header | pointer to Value Chain>, ordered by value. The |
| | Count field indicates the length of the Value |
| | Chain. The array is indexed by NodeID, and there |
| | is a Value Chain for every NodeID. See FIG. |
| | 1B. |
| XLAP | the name of the OLAP engine described in this |
| | document and including the present invention |

XLAP is a system and method including the following unique and novel features. 1) XLAP rolls up all dimensions on every query and is uniquely organized to do so. 2) XLAP's query optimizer chooses the optimum execution path in real time, by using a costing function unique to its mission of rolling up all dimensions all of the time. 3) XLAP re-keys dimensional indexes so that access to key data structures can occur without pointer de-referencing, making the intrinsic engine speed optimal as shown in FIG. 1. 4) XLAP can alter internal data as part of its query engine, providing fast real-time support for complex data mapping rules. XLAP retains these rules internally and can “replay” them against new transactions entering the system. Both the replay and the initial rules application functions are uniquely supported by the XLAP engine itself, rather than by external programs or mechanisms. 5) XLAP can return transaction information as part of its rollup function, in support of transaction data extraction. This innovation applies the power of the OLAP engine to a function that has previously been performed with slow, relational queries. 6) XLAP can reconfigure its Value Chains in real time, in support of hierarchy changes made by the user. 7) XLAP provides a unique “all others” capability that allows for the real-time creation of new hierarchy nodes that represent large numbers of other nodes, so that the OLAP analysis can treat those nodes as a single entity. 8) XLAP can “write back” changes made to its in-memory configuration to its permanent backing store at any time. 9) XLAP creates result sets and sorts pieces of them on demand, thus optimizing query time, rather than building an entire result set “tree” on every query.

The standard operation of the XLAP is as follows: 1. Every OLAP query is a logical narrowing against one or more dimensions. For example, suppose a user wanted to look at all Customers billed in the third or fourth quarter for Cleaning Services in the Southwest or Northwest Regions. This query narrows by the TIME dimension (“third or fourth quarter”), by the PRODUCT dimension (“Cleaning Services”), and by the GEOGRAPHY dimension (“Southwest or Northwest Regions”). Within a dimension, the sense of the query is logical “or”-“Southwest or Northwest”, or the degenerate case of a single node—“Cleaning Services.” Between dimensions, the sense of the query is logical “and”. Every OLAP query follows this model. OLAP queries can therefore be generalized as follows: <or clause> AND <or clause> AND . . . AND <or clause>. Each <or clause> is of the form Dx=Ky1 OR Dx=Ky2 OR . . . OR Dx=Kyn, where x is a dimension and yN is a NodeID of that dimension. “AND” means “logical and” and OR means “logical or.” 2. The query is parsed into OR clauses. 3. Inside each OR clause, any implicit OR terms are calculated and expanded out. These implicit OR terms occur when a NodeID designates an intermediate node, and therefore the query is actually against the leaf nodes which roll up to that intermediate node.

4. Each OR clause is ordered by looking at the value chain count for the NodeID's of the terms of the clause, and sorting the list such that the NodeID with longest Value Chain is first. This ensures that the fewest number of comparisons will be made when XLAP attempts to determine the applicability of this OR clause. 5. Each OR clause's Value Chain length is now determined. This is the sum of the Value Chains of its components, divided by two. 6. The Comparison Cost of traversing each OR clause's Value Chain is now calculated. This is the cost of comparing all of the other OR clause's components, per each NodeID in the given OR clause's Value Chain. 7. The Comparison Cost is divided by a factor K, which is the ratio of the expense of a compare versus the expense of a Value Chain traversal. The result is then added to the Value Chain Length to give the Final Cost of the traversal.

8. The Result Array, allocated in a contiguous memory block, and keyed by NodeID, is cleared optimally (by means of MEMSET). 9. The OR clause with the lowest Final Cost is walked, and each Transaction in that Value Chain is evaluated using the other OR clauses to determine if that Transaction is part of the Result Set. If so, a flag is set in the Result Array. Since the Result Array is keyed by NodeID, this is done with minimal overhead.

10. If a rollup is required (see the description of the XLAP special operation below), the Sibling Chains are walked. 10.1 The Fact Measure Buckets and Dimensional Measure Buckets for all Leaf Nodes are populated with values once at initialization time (or at the Save/Synch time described below). 10.2 All Fact Measure Buckets and Dimensional Measure Buckets for Intermediate Nodes are cleared. The memory for these is allocated as a contiguous block and is cleared optimally (by means of MEMSET). 10.3 Max(Level) is used to index into the Sibling Chain Header array. Each Sibling Chain is traversed in reverse order, from Max(Level) to 1 (one). As the Sibling Chain is traversed, the corresponding Result Array flag is checked. If the flag is set, the amounts in the Fact Measure Bucket and Dimensional Measure Bucket are added to the amounts in the Parent Node's Fact Measure Bucket and Dimensional Measure Bucket.

11. Result requests are processed separately, one level of the tree and one dimension at a time. For each node in a Dimension, its Child Nodes with Results are sorted and returned in sort order. Results may be sorted alphabetically or by value, in inverse or normal order, by any Measure or by the name of the Node. For certain Dimensions with an implicit ordering of Nodes, like Time, XLAP can also sort by this intrinsic ordering.

The XLAP Mapping operation includes steps 1-8 above and the following. 9. As described above, except that as each transaction that would otherwise be marked in the Result Array is identified, a specific NodeID within the Transaction is changed to a specific different NodeID. XLAP can write back mapping changes to its permanent backing store, or batch them for later writeback.

The combination of the above query, the Dimension to be operated on, and the NodeID to be substituted, is called a Mapping Rule. XLAP provides for an indefinite number of Mapping Rules, and every new transaction added to the system is subjected to any applicable Rules.

Mapping is used to clean up datasets and/or create new Dimensions with new semantics. For example, most Payables systems do not have a notion of “Commodity.” It is well known, however, that a combination of General Ledger code and Vendor can uniquely identify Commodity with 97% or better accuracy. Thus, given that a Commodity hierarchy is created within XLAP (see the Save/Synch Operation description below), then transactions are “mapped” to this hierarchy by creating queries that identify groups of transactions that fall into a particular Commodity area. With no information other than GL code and Vendor, therefore, an entire Commodity dimension can be built, on the fly, using mapping rules.

Other uses for Mapping include cleaning up faulty data. Suppose, for example, that a General Ledger code “X” had been retired in favor of the more accurate family of codes, “Y”. Still, however, users forget and use “X” to code transactions. It is possible, using Mapping, to transform all the erroneous “X” attributions, and even the “X” attributions from the past, into the proper “Y” categories, with a series of mapping rules.

The XLAP Transaction Dump operation includes steps 1-8 described above and the following. 9. As described above, except that as each transaction that would otherwise be marked in the Result Array is identified, the unique Transaction ID is recorded in a list. 10. The list of Transaction ID's is used as a single-key index into Fact, to withdraw Transaction information (and Transaction-related information from related Dimensional Index tables).

This means that the XLAP user can reference all information related to a transaction using the OLAP engine to buttress what would otherwise be a lengthy and time-consuming relational query. After XLAP produces a list of transaction ID's, the relational queries to retrieve the remainder of the information can occur at speed, without multi-megabyte join operations.

The XLAP Save/Synch operation is described as follows. At any time, XLAP can make hierarchy changes to its in-memory data structures. At that point, it re-keys its NodeID's and all of its internal data structures to conform to the new hierarchy changes. It then writes these changes to its permanent backing store. When XLAP performs a Save/Synch operation, it also re-calculates the Fact Measure Buckets and Dimensional Measure Buckets for all Leaf Nodes. This is a one-time calculation that speeds future rollups. When XLAP performs a Save/Synch operation, it also re-allocates and re-threads the Fact Measure Buckets and Dimensional Measure Buckets for all Nodes.

What this means in practical terms is that any hierarchy is edited in real time, and new hierarchies are added to the dataset easily and quickly. This is not possible with traditional OLAP systems, which require fixed hierarchies in order to pre-calculate costly joins.

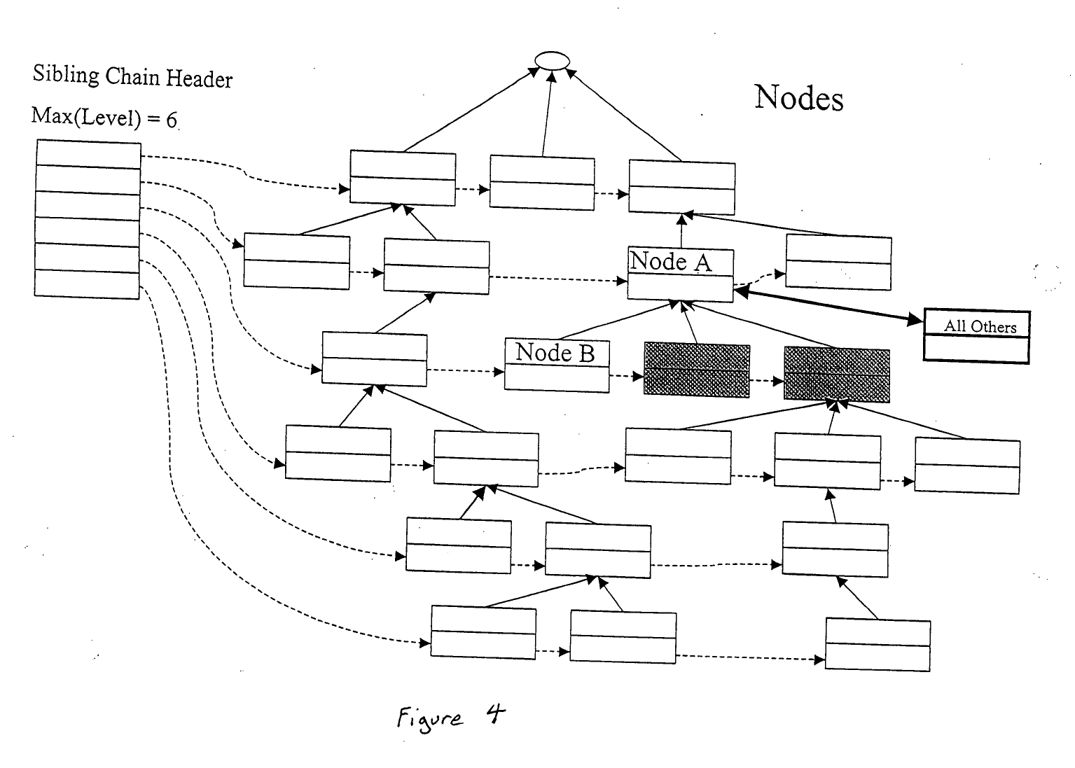

The XLAP All Others operation is described as follows. When XLAP is asked for a results subtree at a particular level K, the requester can ask that only the first N of M nodes at the K level be returned, and that the remainder be reported as “All Others”. XLAP groups the remainder of the nodes, M-N, into an artificial hierarchy, and their measures are rolled up and summed to the temporary hierarchy parent. This parent is called an “All Others” node as shown in FIG. 4. All Other nodes are allocated as needed, on demand. They are never re-used unless the requester indicates, with a special call, that they can be released. This guarantees that later requests against them for results will succeed, should their semantics in the meantime otherwise change with subsequent XLAP engine operations. Thus, All Others nodes can be included in all XLAP analysis results, and used as freely as any other OLAP result. All Others is not, therefore, simply a display convenience. It is in every respect a real result.

The allocation of an All Others node also causes the allocation of Dimensional Measure Buckets and Fact Measure Buckets. Further, the creation of an All Others node at the top of the tree, i.e. at the first level, requires special handling. In this case, the All Others node is chained onto a special holding area, since there is no parent to reference it.

As mentioned above, the present invention is not intended to be limited to a system or method which must satisfy one or more of any stated or implied object or feature of the invention and is not to be limited to the preferred, exemplary, or primary embodiment(s) described herein. Modifications and substitutions by one of ordinary skill in the art are considered to be within the scope of the present invention, which is not to be limited except by the following claims.

1. A method for modifying an in-memory rollup-on-the-fly OLAP engine system with a relational backing store in real time, the acts including:
querying the system in a form of <or clause> AND <or clause> AND . . . AND <or clause>;
responsive to said querying act, parsing the query into OR clauses;
responsive to said parsing act, calculating and expanding out any implicit OR terms inside each OR clause;
responsive to said calculating and expanding act, determining each OR clause's Value Chain length;
responsive to said determining act, ordering each OR clause in a list according to a Value Chain count for a NodeID's of the terms of the OR clause, wherein the list starts with the NodeID having the longest Value Chain length;
responsive to said determining act, calculating a Comparison Cost of traversing each OR clause's Value Chain;
responsive to said calculating act, dividing the Comparison Cost by a factor K, which is the ratio of an expense of a compare versus an expense of a Value Chain traversal, to obtain a result;
responsive to said dividing act, adding the result to the Value Chain Length to obtain the Final Cost of the traversal;
responsive to said adding act, clearing a Result Array via MEMSET;
responsive to said clearing act, walking the OR clause with the lowest Final Cost;
responsive to said walking act, evaluating each Transaction in that Value Chain using the other OR clauses to determine if a transaction is part of a Result Set;
responsive to said evaluating act, flagging the Result Array if the transaction is part of the result set;
responsive to said flagging act, walking the Sibling Chains if a rollup is required;
responsive to said walking act, populating Fact Measure Buckets and Dimensional Measure Buckets for all Leaf Nodes with values once at initialization time;
responsive to said populating act, clearing all Fact Measure Buckets and Dimensional Measure Buckets for Intermediate Nodes;
responsive to said clearing act, allocating the memory for the Intermediate Nodes as a contiguous block;
responsive to said allocating act, utilizing Max(Level) to index into the Sibling Chain Header array;
responsive to said utilizing act, traversing each sibling Chain in reverse order, from Max(Level) to 1 (one);
simultaneous with the traversing act, checking the corresponding Result Array for a flag;
responsive to said checking act, adding amounts in the Fact Measure Bucket and Dimensional Measure Bucket to the amounts in the Parent Node's Fact Measure Bucket and Dimensional Measure Bucket if the Result Array is flagged;
responsive to said adding act, processing the result requests separately, one level of a tree and one dimension at a time; and
responsive to said processing act, sorting and returning the results in a sort order each node in the Dimension, its Child Nodes with Results are sorted and returned in sort order.

2. The method according to feature 1, wherein each of the <OR clause> is of the form Dx=Ky1 OR Dx=Ky2 OR . . . OR Dx=Kyn, and x is a dimension and yN is a NodeID of that dimension, and wherein “AND” means “logical and” and OR means “logical or.”

3. The method according to feature 1, wherein the determining act is a sum of the Value Chains of its components divided by two.

4. A method according to feature 1, wherein the responsive act is to change a specific transaction field by setting it to a passed value, for all transactions flagged by the Result Array.

5. A method according to feature 4, wherein the altered transactions are written from main memory to a backing store.

6. A method for modifying an in-memory rollup-on-the-fly OLAP engine system with a relational backing store in real time, the acts including:
specifying a Dimension and a Threshold for a number “K” of Nodes to be returned;
responsive to said specifying act, performing a Query according to claim 1, wherein only the first K of N Child Nodes for a specified level for a specified Dimension in a specified sort order are returned, where K<N; and
responsive to said performing act, grouping the remaining N-K nodes under a newly-allocated All Others node, rolling up the results of those N-K nodes pursuant to the adding act of claim 1, and returning that node as the K+1th and final node.

7. A method for modifying an in-memory rollup-on-the-fly OLAP engine system with a relational backing store in real time, the acts including:
modifying hierarchies with a hierarchy editor;
responsive to said modifying act, directing the engine to reconfigure itself to support the hierarchy changes;
responsive to said directing act, re-allocating and re-threading Fact Measure and Dimensional Measure Buckets for all Leaf Nodes;
responsive to said directing act, re-allocating and re-threading Fact Measure Buckets and Dimensional Measure Buckets for all Nodes;
responsive to said re-calculating, re-allocating, and re-threading acts, writing hierarchy changes from main memory to a backing store.
